(19) United States
(12) Patent Application Publication
(10) Pub. No.: US 2016/0232370 A1
(43) Pub. Date: Aug. 11, 2016

(54) GRAPHICAL INTERACTION TECHNIQUES FOR CONFIGURING AN ACCESS CONTROL MECHANISM IN A COMPUTER SYSTEM

(71) Applicant: AXIOMATICS AB, Stockholm (SE)

(72) Inventors: Erik RISSANEN, Stockholm (SE); Fredrik HERNEGREN, Stockholm (SE); Andres MARTINELLI, Stockholm (SE); Elisabet Johanna ENLUND, Stockholm (SE)

(73) Assignee: AXIOMATICS AB, Stockholm (SE)

(21) Appl. No.: 14/793,400

(22) Filed: Jul. 7, 2015

(30) Foreign Application Priority Data
Feb. 6, 2015 (SE) 1550137-2

(51) Int. Cl. G06F 21/62; G06F 17/30; G06F 21/31

(52) U.S. Cl. CPC G06F 21/6218; G06F 21/31; G06F 17/30327

(57) ABSTRACT

An attribute-based access control (ABAC) policy governs the behaviour of an access control mechanism in a computer system which selectively permits and denies access to resources in the system. An administrator interface includes graphical elements that are responsive to user manipulation in such manner as allow the ABAC policy to be inspected and/or edited. In an online editing mode, a user's manipulations of the graphical representation have a direct effect on the behaviour of the access control mechanism.

### TECHNICAL FIELD

The invention disclosed herein generally relates to the field of automated access control in computer systems. In particular, the invention relates to graphical interaction techniques for configuring an access control mechanism which selectively permits and denies access to resources in a computer system. It is contemplated to implement the interaction techniques as part of a graphical user interface (GUI) in a policy administration point associated with the access control mechanism.

### BACKGROUND

On a high level, attribute-based access control (ABAC) may be defined as a method where a subject's requests to perform operations on resources are granted or denied based on assigned attributes of the subject, assigned attributes of the resource, environment conditions, and a set of one or more policies that are specified in terms of those attributes and conditions. Here, attributes are characteristics of the subject, resource, or environment conditions. Attributes may further be defined to reflect characteristics of an action performed on or in respect of a resource. Attributes contain information given by a name-value pair, which may be single-valued or multiple-valued. A subject is a human user or non-person entity, such as a device that issues access requests to perform operations on resources. Subjects are assigned one or more attributes. A resource (or object) is a system resource for which access is managed by the ABAC system, such as devices, files, records, tables, processes, programs, networks, or domains containing or receiving information. It can be the resource or requested entity, as well as anything upon which an operation may be performed by a subject including data, applications, services, devices, and networks. An operation is the execution of a function at the request of a subject upon a resource. Operations include read, write, edit, delete, copy, execute and modify. Environment conditions describe an operational or situational context in which an access request occurs. Environment conditions are detectable environmental characteristics. Environmental characteristics are generally independent of subject or resource, and may include the current time, day of the week, location of a user, or the current threat level. Finally, a policy is the representation of rules or relationships that makes it possible to determine if a requested access should be allowed, given the values of the attributes of the subject, resource, and possibly environment conditions. A policy may be expressed as a logical function, which maps an access request (or decision request) with a set of attribute values (or references to attribute values) to an access decision (or an indication that the request has not returned a decision).

An ABAC authorization scenario is depicted in FIG. 3. In step 1, a user (or subject) 301 requests access to a resource 151 through the intermediary of an ABAC mechanism 302 which selectively protects access to the resource 151. The ABAC mechanism 302 forms a decision by retrieving, in step 2a-2b-2c-2d, applicable rules R1, R2, R3 from a policy repository 190, subject attributes (e.g. name, affiliation, clearance) from a subject attribute data source 303, resource attributes (e.g. type, owner, classification) from a resource attribute data source 304, and environment conditions expressed as environment attribute values from an environment attribute data source 305. If the ABAC mechanism 302 is able to determine that the decision is to permit access, it will take appropriate measures to grant the user 301 access to the resource 151, e.g. by selectively deactivating a hardware or software protection means. Otherwise, access to the resource 151 may be denied.

There currently exist general-purpose ABAC policy languages that have the richness to express fine-grained conditions and conditions which depend on external data. A first example is the Extensible Access Control Markup Language (XACML) which is the subject of standardization work in a Technical Committee of the Organization for the Advancement of Structured Information Standards (OASIS, 35 Corporate Drive, Suite 150, Burlington, Mass., 01803-4238, USA). A policy encoded with XACML consists of declarative (in particular, functional) expressions in terms of attributes, and the return value (decision) of the policy is one of Permit, Deny, Not Applicable, or Indeterminate. An XACML policy can apply to many different situations, that is, different subjects, resources, actions and environments and may give different results for them. The XACML specification defines how such a request is evaluated against the policy, particularly what policy attributes are to be evaluated or, at least, which values are required to exist for a successful evaluation to result. A key characteristic of this evaluation process is that the request must describe the attempted access to a protected resource fully by containing information sufficient for all necessary attribute values to be retrieved. In practice, it may be that the request is interpreted in multiple stages by different components, so that a PEP (Policy Enforcement Point) issuing the requests provides only some attribute values initially, and a PDP (Policy Decision Point) or other component responsible for the evaluation can dynamically fetch more values from remote sources as they are needed. A second example is the Axiomatics Language For Authorization™, which the applicant provides.

With regard to terminology in XACML, it is noted that “policy” may on the one hand have the meaning defined above—a representation of rules or relationships that makes it possible to determine if a requested access should be allowed—and, on the other, may refer to a type of element titled Policy inside such a representation of rules and relationships. The term “policy”/“Policy” will be used in both senses in this disclosure, though each particular occurrence should be unambiguous.

XACML-based solutions typically offer “authorization as a service”, wherein a PEP in a target application/system captures access requests in real time and sends them to a PDP for evaluation against a current version one or more XACML policies. Such externalized authorization approach ensures continuity in that it drastically reduces or eliminates the latency between an update of the policy and actual enforcement of the new rules therein.

Available PDP implementations are typically configured to implement a text representation of an ABAC policy, which it retrieves from a policy repository, and are unable to accept ABAC policies in other formats. Likewise, an administrator desiring to update the policy stored in the repository must do so by submitting, through the available administration interface, a new version in text format. Clearly, the administrator interface would as well reject incremental changes that were requested in non-textual form.

### SUMMARY

It would be desirable to reduce or at least mitigate the above limitations associated with the prior art. In particular, it would be of technical advantage if a currently enforced ABAC policy could be visualized for inspection and analysis in graphical form. In particular, it would be advantageous to visualize to an administrator how a change in an ABAC policy affects access rights in the system, and more precisely to visualize abstract elements of the ABAC policy that have hitherto not been represented graphically. Furthermore, it would be advantageous to provide an administrator interface with graphical elements that are responsive to user manipulation in such manner as to allow an ABAC policy to be input, extended and/or edited. It would be of further advantage if the user's manipulations are not only reflected in a displayed representation of the ABAC policy but also associated with a direct effect on the behaviour of the access control mechanism operating in the computer system. Still further, it would be advantageous to provide a consistency-testing functionality operating at the level of the graphical representation and visualizing its outcome in graphical form.

More precisely, some of the potential technical advantages may be a reduced latency between administrator interface and the access control mechanism; a reduced failure risk since input errors may be discovered more easily and/or by a broader personnel base; more efficient use of an available screen area, as a graphical representation of an ABAC policy may oftentimes occupy less space than a representation by text of legible font size; less time-consuming input, editing and verification processes. Furthermore, the inventors have taken care to structure the graphical representation of the ABAC policy in such manner that translation to and from a textual, machine-interpretable representation is possible in very limited time even in a normal runtime environment; therefore, for practical purposes, the graphical representation is quasi machine-interpretable in itself, so that an administrator may be able to inspect and edit a graphical representation of an ABAC policy that is currently being enforced in the computer system. By virtue of this, real-time or quasi real-time maintenance of the ABAC policy is possible in graphical form, so that valuable downtime of the access control mechanism can be reduced or avoided. The final design of the graphical representation may be developed to be pleasing and intuitive to the user, but in principle does not form part of the invention.

As used herein, a text representation is an arrangement of characters selected from predefined font tables (e.g., characters from one chosen alphabet or script, such as Roman or Greek letters, diacritics, digits, mathematical operators and the like), whereas a representation in graphical form may be understood as a representation going beyond a pure text representation. For instance, a graphical representation may include bitmaps, vector graphics, ideograms and other images, these non-textual elements optionally appearing in combination with textual elements, such as single characters, words, lines and paragraphs. It is envisaged that a graphical representation may include characters of a specialized drawing font adapted to be arranged into lines, boxes, curves, shapes and the like (e.g., characters ┌ ┐ ┘ └ [symbol] ┤ [symbol] [symbol] ▴ □ [symbol] ).

At least some of the above advantages are achieved by methods, devices and computer program products having the features set forth in the independent claims appended hereto. Further example embodiments are defined by the dependent claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs appearing in the claims are not to be understood as limiting their scope.

### BRIEF DESCRIPTION OF THE DRAWINGS

Example embodiments of the invention will now be described in greater detail and with reference to the accompanying drawings, on which:

FIG. 1 illustrates an example graphical representation of an ABAC policy;

FIG. 2 illustrates a dual-window interface for administering an ABAC policy;

FIG. 3 illustrates an access scenario in accordance with an ABAC authorization model;

FIG. 4 illustrates key functional components of an ABAC implementation; and

FIG. 5 illustrates a graphical representation associated with a Target-type element.

Unless otherwise stated, the drawings generally show only such components and elements that are necessary to illustrate the present invention; other components and elements may have been intentionally omitted for the sake of clarity.

### EXAMPLE EMBODIMENTS

### 1. ABAC Implementation

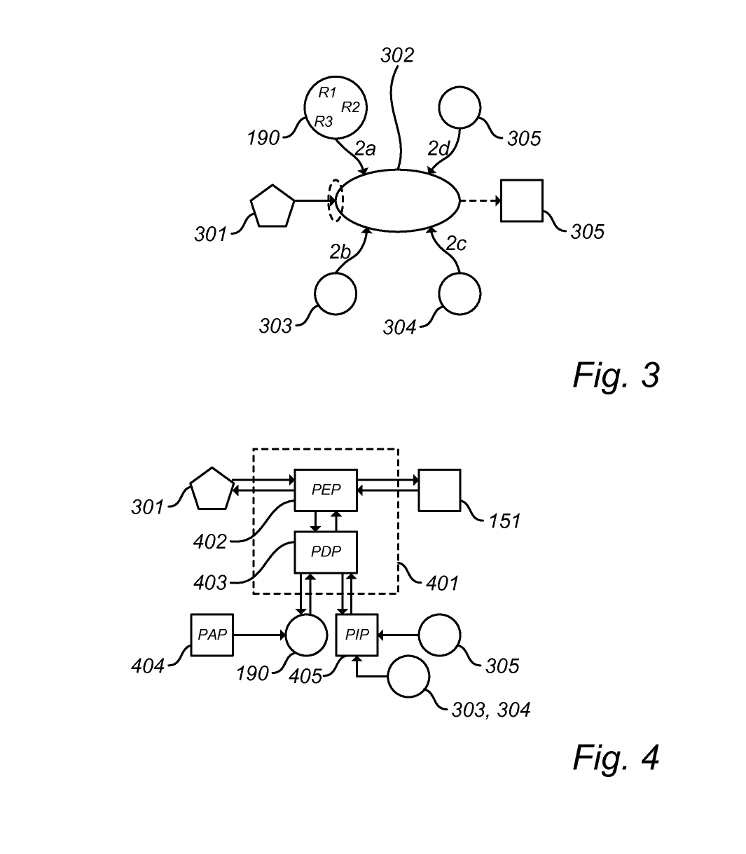

FIG. 4 illustrates an example implementation of the ABAC model shown in FIG. 3, as well as possible flows of information when authorization services 401 process a subject's 301 request to access a resource 151 by using or performing an action on the resource 151. The authorization services 401 include a policy enforcement point (PEP) 402, which selectively permits or prevents the subject's 301 access to the resource 151, e.g. by selectively activating and deactivating hardware or software protection means, and a policy decision point (PDP) 403.

The access request is to be evaluated against an ABAC policy in a policy repository 190, which may be maintained from a policy administration point (PAP) 404. The PDP 403 may configured to retrieve necessary information describing the ABAC policy from the repository 190. From a policy information point (PIP) 405, the PDP 403 may request any such values of policy attributes that are missing from the initial access request but necessary to evaluate the request against the policy. In turn, the PIP 405 may request these values from an attribute repository 303-304 storing values of subject and resource attributes (in this sense, the repository may be seen as an entity combining the functionalities of the data sources 303 and 304 in FIG. 3 and has been labelled accordingly) and/or from an environment conditions repository 305. The evaluation of the access request may then complete, and a decision may be returned to the subject 301. If the decision is permissive, the PEP 402 grants access to the resource 151, as requested.

### 2. Structure of an ABAC Policy

An ABAC policy (or ABAC policy set) may be a set of ordered elements. An element may be a functional expression (example: PolicySet, Policy, Rule), which is susceptible to evaluation by accepting input data and providing output data in response hereto. Functional expressions in terms of the elements may be hierarchically ordered in such manner that one functional expression accepts, as its input data, the output data of one or more subordinate expressions. If the data from the subordinate expressions are necessary for evaluating the parent expression (e.g., it influences the output of the parent expression non-trivially), then evaluation of the parent expression cannot complete until after the subordinate expression has been finally evaluated. Further, an element may be a container expressing a property of an associated element (example: Description, which may be associated with a PolicySet).

It is possible to combine the outputs of standard-type functional expressions using a standard-type logical, mathematical etc. operator (examples: arithmetic addition operator combining numbers, logic AND operator combining Boolean values). For ABAC-specific functional expressions, which as their output may have decisions such as Permit, Deny, Indeterminate, NotApplicable etc., an ABAC policy may further include a combining algorithm, by which a definite decision is arrived at on the basis of two or more decisions from subordinate ABAC-specific functional expressions (example: a deny-overrides combining algorithm joining two Rules with effect Deny).

Specifically, the ABAC policy may be in accordance with an XML language, such as a dedicated access control language, such as XACML. Detailed information on standardized policy syntax and functional requirements is available from OASIS for current (February 2015: version 3.0) and previous releases of XACML. It is expected that future releases of XACML will be backward compatible to a considerable extent, so that many elements of the present invention and teachings contained in this disclosure remain applicable.

An ABAC policy in XML typically is machine-interpretable without any prior compilation step; available generic XML parsers, including SAX and DOM, can be used for this purpose. In at least some available ABAC authorization products, an administrator who is able to work with a textual representation of an ABAC policy may therefore inspect a policy that is being actually enforced by the access control mechanism in the computer system. Similar, any edits the administrator makes in the ABAC policy may be forwarded for enforcement by the access control mechanism (e.g., by a commit-type command) without the delay associated with—and potential errors incurred by—a preceding compilation step.

### 3. Machine-Interpretable Graphical Representation

By the methods and devices proposed in this disclosure, a textual representation of an ABAC policy (e.g., in XACML format mainly using Roman characters, digits and standard operator characters) may serve as a basis for generating a graphical representation of an ABAC policy that is either identical to the textual representation or at least equivalent in the sense that the graphically represented policy returns identical access decisions in response to identical access requests. Conversely, an textual representation of an identical or equivalent ABAC policy may be generated on the basis of a graphical representation. Elements of the graphical representation may contain metadata facilitating the back-conversion into textual form.

It is envisaged that a textual and a graphical representation of one same ABAC policy may be displayed and edited in parallel, e.g. as two selectable modes in a policy administrator interface. The policy administrator interface may be associated with an entity serving as policy decision point, see FIG. 4. The interface may be provided as a web application via a browser or other thin client. A user input requesting a mode toggle may then trigger a transformation of the ABAC policy from the representation format associated with a current mode into the representation format associated with the other mode, possibly triggering updates in view hereof to be made to a most recent copy of this representation; depending upon how the administrator interface has been implemented, it may be expedient to perform only an incremental transformation, such as one targeting only those elements that have undergone user manipulation during the current session in the selected mode.

By the above functionalities, it may be possible to provide a graphical displaying and editing mode of a policy administrator interface that may serve as a visual programming interface specialized for ABAC policies, hence a tool for inspecting, controlling and defining the behaviour of an access control mechanism in a computer system. The policy administrator interface may be operated in an offline mode and an online mode (each offering a selection of either graphical or textual editing and display). In the online mode, the user's manipulation of the ABAC policy representation may have direct effect on the behaviour of the access control mechanism in the computer system. In the offline mode, the user's manipulations may be given effect after a “commit”, “update” or “apply” command has been given.

In an example embodiment, a graphical representation of an arbitrary syntactically compliant ABAC policy may be generated by defining a symbol being a graphical counterpart of each element of a policy that is allowed under a predefined policy syntax and optionally of allowed relationships between the elements too, such as dependency, hierarchic order etc. In the interest of clarity, ease of learning and limiting the computational load on an processor executing the administrator interface, different allowed elements or relationships in a policy may share a common symbol. Additionally or alternatively, some allowed elements or relationships in a policy may be represented textually, or as metadata associated with one of the symbols. For instance, the administrator may interact (e.g. using a cursor) on one of the symbols to add, inspect or edit associated metadata. As an example, at least some of the symbols forming the graphical representation may be viewable in a normal (where metadata are invisible or only partially visible) and an expanded (where metadata are visible) mode, between which the user of the administrator interface may toggle. The expanded mode may be referred to as a metadata edit mode. Additionally or alternatively, some allowed elements or relationships may be displayed adjacent to one another while others may be displayed separated, in particular in different screen areas.

The inventors' purposeful selection, for each allowed element or relationship of a policy, whether the element/relationship is to be represented graphically or by metadata, what elements/relationships are to share a common symbol, and what elements/relationships are to be grouped together visually, has been arrived at after considering the ABAC model, the structure of an ABAC policy and the functioning of an access control mechanism which the policy controls.

### 4. Specific Features of the Graphical Representation: Tree Structure

In one example embodiment, it is proposed to use a two-dimensional shape (e.g., circle, square, oval, rectangle, polygonal shape) to represent elements corresponding to XACML elements PolicySet, Policy and Rule. Preferably, the symbols for all of these elements may have the same contour and size but may differ as to their contour line style, in particular the colour of the line. Further preferably, an element corresponding to XACML element Description associated with a PolicySet, Policy or Rule is represented as a visible text string (truncated if necessary to fit) in each shape. This is to say, the element Description is represented textually.

If the ABAC syntax so allows, a new PolicySet, Policy or Rule element may be defined by reference to an existing element of the same type. In an example embodiment, a PolicySet, Policy or Rule element defined by reference may be represented by a symbol having the same contour and shape but differing with regard to its contour line style and/or colour.

Preferably, two or more shapes may be connected by connectors, in particular lines, to reflect a dependency in the ABAC policy. For instance, a hierarchic dependency between a Policy element and N≧1 Rule elements may be graphically represented as a line or curve starting from the Policy element, extending in a predetermined direction (for instance, geometric up/down may signify policy-hierarchic higher/lower, or geometric left/right may signify policy-hierarchic higher/lower) towards the Rule elements, and then bifurcating into N endpoints connecting to each of the Rule elements. Because of the connection lines, the totality of the graphical representation of the ABAC policy may be said to have the appearance of a (possibly rotated) tree. The tree-like structure reflects the hierarchy structure of the policy elements, i.e., the symbols making up the tree-like structure are in a consistent relationship with the PolicySet, Policy and Rule elements of the ABAC policy.

The inventors have considered the option of organizing the PolicySet, Policy and Rule elements in accordance with the subjects and resources to which they pertain. For instance, it would be possible to visualize all Rule elements that apply to a certain user (subject) or group of users in geometric proximity of one another. As a further alternative, it would be possible to collect all symbols representing Rule elements that apply to a certain resource or group of resources. Further still, it would be possible to reflect relationships that exist among users or among resources to which such Rule elements apply. This notwithstanding, the inventors have realized that, although a resource- or user-focused hierarchic structure of the graphical representation may have been potentially more appealing or intuitive to some users of the administrator interface, a graphical representation reflecting the internal dependencies between the policy elements—as described above—is technically more advantageous. In particular, a representation of this type may lend itself to rendering by a linear traversal of the ABAC policy, without an absolute necessity to rearrange the symbols thus generated.

The description of the example embodiment initiated above will now be resumed. Where a PolicySet, Policy or Rule element depends from two or more subordinate Policy or Rule elements, a combining algorithm element of the type introduced above may be used to determine a unique decision on the basis of the outputs of the subordinate elements. For a specific PolicySet or Policy element, a combining algorithm may be selected from a menu which is available when the element is in the metadata edit mode, as outlined above. It is assumed that the number of available combining algorithms is limited and lends itself to memorisation by a skilled user. In an example embodiment, the type of combining algorithm that a superordinate element is configured to apply is indicated by a mnemonic acronym in a specific area inside or next to the shape representing the superordinate element. For instance, XACML combining algorithm permit-overrides may be indicated as “PO” in this area, and first-applicable may be indicated as “FA”. Hence, in this example embodiment, which is freely combinable with the features explained above, the inventors have found it suitable to refrain from representing all elements of the ABAC policy geometrically but have concluded that a purposeful combination of textual and non-textual components is more adequate.

In an example embodiment, the generation process of a graphical representation of several elements on a same level of the policy hierarchy preserves the order in which these elements are defined in the underlying textual representation of the policy. Also, if a user of the administrator interface adds a further child to an element of a graphically represented policy, the new child is added in the location that the user indicated. Put differently, this example embodiment inhibits sorting (or re-sorting after addition) of policy elements on a same level in, say, alphabetical order. An advantage associated with such absence of sorting is that the XACML combining algorithm first-applicable (and its equivalents in other syntaxes) will function consistently. If the elements had been sorted in a particular order, the graphical representation of an ABAC policy may have failed to be fully equivalent to the textual representation.

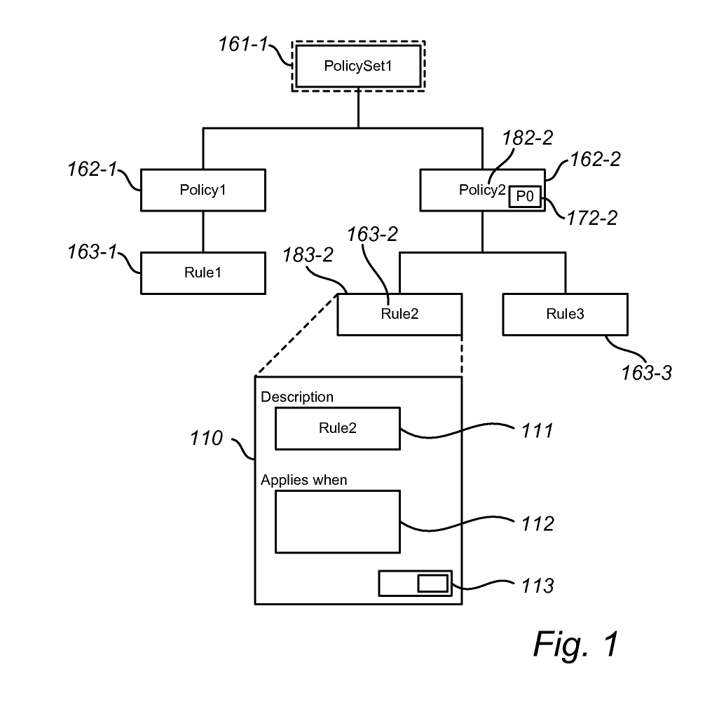

FIG. 1 shows an example graphical representation of hierarchically related PolicySet elements 161-1, Policy elements 162-1, 162-2 and Rule elements 163-1, 163-2, 163-3. Symbols of similar shapes have been used for all three types of elements, but the line styles differ to make them visually distinguishable. A policy algorithm for Policy element 162-2 is indicated in field 172-2, next to Description text 182-2 of the element. A policy-hierarchic ‘lower’ direction is down, that is, the subordinates of a given element are found by following a line or lines, if such exist(s), extending downward from the element. In FIG. 1, a Rule element 163-2 is shown in a metadata edit mode, wherein a window 110 is shown with two editable fields 111, 112 labelled “Description” and “Applies when” and one two-position slider 113. As proposed above, the “Description” field corresponds to a value (example data type: string) of an attribute of a Description element associated with the Rule element 163-2. The second editable field 112 may be adapted for both textual and graphical representations. A user of the administrator interface showing the Rule element 163-2 in the metadata edit mode can revert to the normal mode by closing the window 110. Preferably, the text of the Description element is shown in non-editable format in the normal mode, item 183-2.

### 5. Specific Features of the Graphical Representation: Navigation Tools

An ABAC policy which governs the behaviour of an access control mechanism in a computer system of an enterprise with a large number of subjects and resources may occupy several thousands or millions of characters when represented textually. This is in particular so if the population of subjects and/or resources is inhomogeneous, or the computer system is designed to operate in a broad range of changing conditions. It goes without saying that a graphical representation of such an ABAC policy may as well be unwieldy and difficult to fit into a normal personal computer screen without sacrificing visibility. In example embodiments, the inventors have proposed the following measures—to be used singly or in combination—for enabling efficient inspection and editing of such an ABAC policy in an administrator interface.

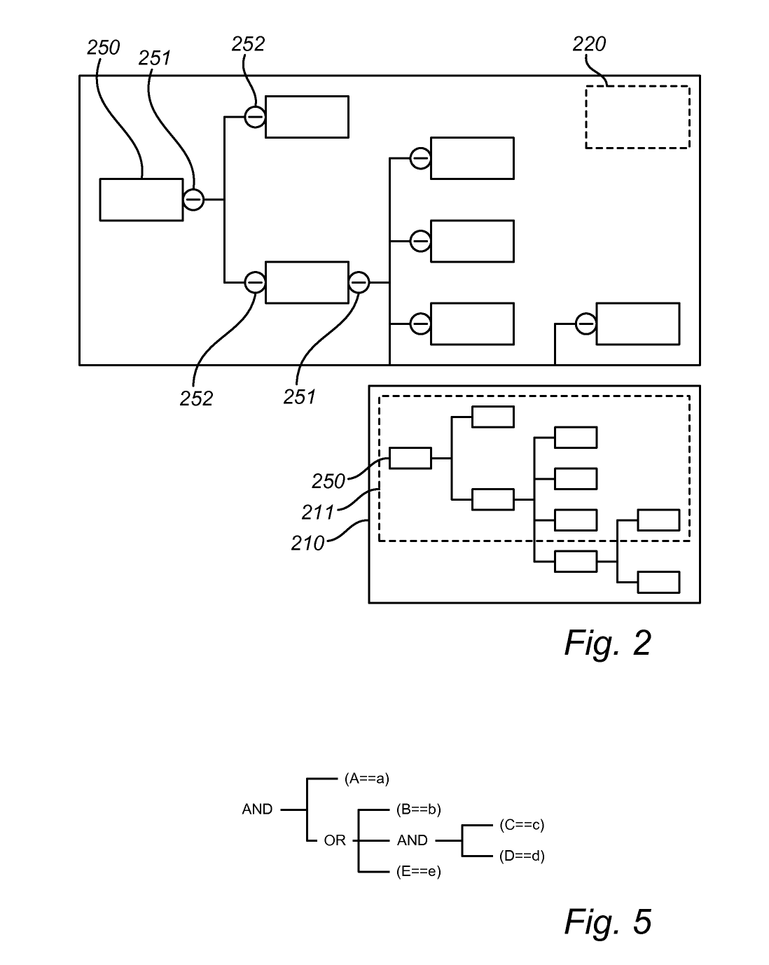

These measures are exemplified in FIG. 2, in which an ABAC policy comprising elements at four hierarchic levels is shown represented as a tree 250, with the hierarchic ‘lower’ direction being oriented to the right on the drawing. In addition to the symbols already introduced with reference to FIG. 1, each of the PolicySet, Policy and Rule elements comprises a lower collapse control 251 and/or an upper collapse control 252. A lower collapse control 251 is used to select whether subordinate elements are to be displayed (lower expanded mode) or not (lower collapsed mode). An element in the lower collapsed mode will have the appearance of a leaf node of the tree structure. As suggested in FIG. 2, there is no need to equip elements that are leaf nodes in the tree (i.e., representing elements in the ABAC policy that lack subordinate elements) with a lower collapse control. Hence, a lower collapse control is absent from such symbols that represent Rule elements. An upper collapse control 252 is used to select whether superordinate elements are to be displayed (upper expanded mode) or not (upper collapsed mode). An element in the upper collapsed mode will have the appearance of a root node in the tree structure, and there is consequently no need to provide the root node (e.g., PolicySet element) with an upper expand control. In example embodiments, the administrator interface is configured to preserve a connected state of the tree structure, namely, by hiding in the upper collapsed mode not only the superordinate elements but also all other neighbouring elements of the same hierarchic level. In the example shown in FIG. 2, two upper collapse controls 252 are indicated, namely associated with the two level-2 elements. If one of these is actuated to enter the upper collapsed mode, in which the root node (or level-1 element) is hidden, then as a consequence, the other level-2 element becomes hidden as well.

As a further measure to facilitate management of a large ABAC policy, the administrator interface shows one same graphical representation of the policy both in a main window 200 and an overview window 210. While the main window 200 can be zoomed in or out to the desired resolution, the overview window conveys a view of the full policy representation while showing a frame 211 indicating the current extent of the main window. This way, the user of the administrator interface may maintain a general impression of those portions of the graphical representation that currently do not fit into the main window.

It is contemplated that the overview window 210 may be located next to the main window 200 or as an insert (or overlay) in the main window 200, such as in the area 220 suggested by a dashed contour.

Preferably, the ABAC policy is visualized in a simpler fashion in the overview window 210. For instance, as suggested in FIG. 2, the collapse controls 251, 252 and/or the Description text may be omitted. Preferably, the interactivity is simplified as well, e.g., in that the administrator interface is configured without any reaction to cursor manipulation in the overview window 210.

As a still further measure to facilitate management of a relatively large ABAC policy, the administrator interface may be provided with a search functionality for retrieving textual information associated with symbols graphically representing elements of the ABAC policy. The textual information may relate to both metadata and text in Description elements. Because the metadata text may be visible in the metadata edit mode but not in a normal viewing mode, as already discussed, a user of the administrator interface who is looking for a particular text string may be reduced to entering the metadata edit mode for each of the graphically represented policy elements separately, e.g. in a linear fashion or guided by the user's expectations as to where the text is located. As such, it may be very time-consuming for a user to find specific search phrase in metadata, a need which arises for instance when all occurrences of a given resource or a given subject are to be located.

The search functionality may for instance return the search hits in a hit list in text format. Alternatively or additionally, the graphical representation of those elements of the ABAC policy that contain the search phrase are highlighted.

An efficient implementation of the search functionality may be simplified if, during generation of the graphical representation of an ABAC policy, markers are inserted into interpretation-exempt portions of the textual representation of the ABAC policy (e.g. in comments or annotation fields) or a copy thereof. This way, an annotated textual representation of the ABAC policy is created. A marker may be a unique identifier of a symbol in the graphical representation of the ABAC policy. As such, when a search query pertaining to a textual search phrase is submitted in respect of the graphical representation of the ABAC policy, the search is carried out in the annotated textual representation of the ABAC policy, and the locations of the search hits are translated into symbols of the graphical representation. The search hits may then be displayed in the manner outlined above. Alternatively, the symbols of the graphical representation may carry metadata annotations, which have been added when the symbols were generated from the textual representation, with references to specific portions of the textual representation of the ABAC policy. Line numbers may be used to refer to those specific portions. If the annotations are additionally collected in a look-up table maintained in addition to the graphical and textual representations of the ABAC policy, the search for the search phrase may be carried out in the textual representation (without annotations), upon which the look-up table can be used to find the corresponding symbols of the graphical representation, so that highlighting or other visualization can be added in order to show the locations of the search hits in the graphical representation.

### 6. Specific Features of the Graphical Representation: Rule Elements

A graphical representation of an XACML Rule element or elements equivalent thereto under different ABAC syntax may be associated with a Condition element, a Target element and may be associated with a value of a variable indicating the effect of the Rule element (e.g. to permit access or deny access), which effect is to be executed by the access control mechanism if certain requirements are fulfilled. More precisely, when a policy decision point evaluates an access request against an ABAC policy, the effect configured for a given Rule element may be executed by an access control mechanism (e.g., a policy enforcement point) when both the requirements in the Condition element and the requirements in the Target element are fulfilled. A preferred order of execution is to initially evaluate the requirement set forth in the Target element and then, if this requirement is fulfilled, to go on to the requirement defined in the Condition element.

A symbol representing a Rule element is preferably provided with a toggle switch (e.g., a two-position slider, as shown at item 113 in FIG. 1) which may be set in a “permit” position and a “deny” position representing the configured effect of the Rule element and which may react to manipulation by a user of the administrator interface. The use of a toggle switch for configuring an effect of a Rule element is advantageous since it eliminates an error state corresponding to an incorrect (not allowed) value and an error state corresponding to a deficient (absent) value.

A Target element may be shown, for instance in the editable field 112 of FIG. 1, represented semi-graphically. At least some ABAC syntax stipulates that the requirement of a Target element be defined in accordance with a grammar requiring the Target element to have a conjunctive sequence of AnyOf elements, wherein each AnyOf element must have a disjunctive sequence of AllOf elements, wherein each AllOf element must have a conjunctive sequence of Match elements. Conceptually, the elements may be thought of as functions with the following domains and ranges:

| | |
|---|---|
| Target: | {Match, No match, Indet.}^{N} → {Match, No match, Indet.} |
| AnyOf: | {Match, No match, Indet.}^{N} → {Match, No match, Indet.} |
| AllOf: | {True, False, Indet.}^{N} → {Match, No match, Indet.} |
| Match: | attribute value(s) → {True, False, Indet.} |

wherein “Indet.” denotes an error state (Indeterminate), and it is understood that a positive integer value is assigned to each occurrence of N independently of the other occurrences. In view hereof, the simplest possible Target element is of the following form:

Target(AnyOf(AllOf(Match( . . . )))),

wherein the final Match element contains a comparison in terms of string, Boolean, float, integer, date or other values of to attributes, as defined by an administrator or author of the ABAC policy. An example grammar from standardized policy syntax may found in OASIS Standard XACML Release 3.0, in sections 5.6-5.9 and 7.6-7.7 in particular.

The following example Target-compliant expression,

Target( AnyOf( AllOf( Match( A == a ) ) ), AnyOf( AllOf( Match(
B == b ) ), AllOf( Match( C == c ), Match( D == d ) ), AllOf( Match(
E == e ) ) ) ),

may be transformed into a corresponding Boolean expression, as follows:

(A==a) AND ((B==b) OR ((C==c) AND (D==d)) OR (E==e)). (1)

It is understood that Boolean true/false are taken to correspond to Match/No match, and the error state Indeterminate is not handled. Here, uppercase letters may refer to attributes and lowercase letters may refer to constants; the operator “==” may express a general relationship, such as inequality, equality, inclusion, and may act upon data of an arbitrary type. It is noted for completeness that comparisons of two attributes may generally be defined as well.

While some users of the administrator interface, in particular non-experts in ABAC, may experience difficulties in forming Target-compliant expressions, the users are oftentimes familiar with Boolean formalism. For this reason, in example embodiments, the administrator interface accepts input of Target-type expressions in graphical format and is configured to translate such expressions into a textual representation compliant with the Target-type grammar explained above. The graphical format is a tree-like structure, in which comparisons such as “A==a” are found at leaves, and names or symbols for the Boolean operators AND and OR are indicated at bifurcation points of the structure. As an illustration, a graphical representation of the expression in equation (1) is depicted in FIG. 5.

In example embodiments, the editable field 112 is further provided with controls for editing the graphical representation shown therein. Such controls may correspond to the actions “Add AND bifurcation”, “Add OR bifurcation”, “Delete subtree” and/or aids for entering comparisons including an attribute dictionary (or menu), a comparison operator menu. Furthermore, each Match element carries an indication (e.g., a colourful dot) indicating a status of required presence. This is to say, the absence of an attribute value to which the Match element refers is not taken to imply that the comparison is trivially true; instead, if required presence has been indicated the Match element outputs an error state.

As an alternative to structures of the type shown in FIG. 5, the inventors have considered an and-or tree, which is known and used in other technical and theoretical fields, with the comparisons at its leaf nodes. In an and-or tree, there are no bifurcating connection lines, but all connection lines extend directly from the parent node to the child nodes. Free connection lines extend to mutually disjunctive conditions (or comparisons) while two or more connection lines that are joined by a common arc extend to such conditions that are part of a conjunctive set. And-or trees are believed to be inferior to graphical representations of the type exemplified in FIG. 5, since they include features that are difficult to discern if rendered at limited resolution, such as on simple visual displays, and so are less space-efficient.

A constructive process for generating a structure of the type exemplified in FIG. 5 on the basis of a Target-compliant expression may be to traverse the expression starting from the root node and applying translation rules along the following lines.
A1. A presence of N≧2 AnyOf elements inside the top Target element is translated into an AND bifurcation with N children.
A2. A presence of N≧2 AllOf elements inside an AnyOf element is translated into an OR bifurcation with N children.
A3. A presence of N≧2 Match elements inside an AllOf element is translated into an AND bifurcation with N children.
A4. A single AllOf element is not translated.
A5. An AnyOf element containing only one AllOf element is not translated.
A6. A Target element containing only one AnyOf element is not translated.
A7. A single Match element is not translated. Its content is translated into a condition at a leaf node.
   As used in these rules, a “single” element is one being the only content of a superordinate element. The translation rules are typically syntax-specific and will need to be adapted to each specific syntax; this is believed to be within the abilities of the average practitioner having studied the present disclosure.

It is furthermore possible to design a converse process, wherein a semi-graphical tree structure of the type exemplified in FIG. 5 is translated into a Target-compliant expression. The process could be initiated with a textual expression “Target(AnyOf(AllOf(Match(true))))”, which by traversing the structure is then extended to a Target-compliant expression that is equivalent to the graphical representation. It will be within the abilities of the average practitioner to adapt rules A1-A6 for the inverse translation task. Together with an input modality, as exemplified above by the editing controls proposed to accompany the editable field 112, such a converse translation process makes available a visual programming tool by which at least portions of an ABAC policy can be defined; indeed, Target-compliant text is generated on the basis of a graphical or semi-graphical representation.

Although the above description of the Target element has been made in connection with the Rule element, a Target element may be associated with a Policy or PolicySet element as well and may then be visualized in a similar manner. In XACML for instance, the Target element identifies the set of access requests (decision requests) that the parent element is intended to evaluate. A Target element appears as a child of a PolicySet and Policy element and may appear as a child of a Rule element.

In an example embodiment, a textual representation is used for displaying and editing Condition elements in Rule, Policy and PolicySet elements of an ABAC policy. Preferably, the administrator interface includes a mode in which the Condition element is edited in a simplified language, such as the Axiomatics Language For Authorization (ALFA), based on which syntax-compliant (e.g. XACML-compliant) policy text is generated. Because ALFA is syntactically similar to Java and C#, it may enable and administrator to develop and edit ABAC policies more easily.

### 7. Specific Features of the Graphical Representation: Input Aids

In an example embodiment, fields in the graphical representation that are configured to receive text input, such as the editable fields 111, 112 shown in FIG. 1, are equipped with entry aids. For instance, an autocomplete functionality may support a user's entry of text, wherein the autocomplete functionality is associated with a dictionary containing reserved words under the ABAC syntax used, or with a list of defined attributes. There may be provided a particular attribute management interface, which includes names and types of defined attributes, as well as any connections to remote attribute sources. The editable field 112 for entering a Target-type expression may furthermore include a first subfield (not shown) for entering an attribute and a second subfield (not shown) for entering a comparison operator; in this setting, the autocomplete functionality may be restricted to the list of defined attributes when it supports input into the first subfield and may be restricted to the list of comparison operators under the ABAC syntax used when it supports input into the second subfield.

Alternatively or additionally, fields for text entry may be equipped with syntax consistency aids, such as one or more of: bracket matching, automatic indentation, highlighting of reserved words, highlighting of defined attributes and automatic syntax consistency verification, wherein the syntax consistency verification may be operating continually or upon user request. In an example embodiment, each Rule, Policy or PolicySet element carries an indicator of whether all information that is mandatory to fulfil syntactic consistency requirements has been entered, or whether the user has yet to make supplementary inputs. The indicator is visible in the normal mode, not only in the metadata edit mode. The element may further carry an indication of a named user responsible for completing its required data fields. The named user may be automatically allocated, say, based on characteristics of a resource to which the represented Rule, Policy or PolicySet element applies, or may be entered by one of the users of the administrator interface.

In an example embodiment, there is provided a functionality indicating all changes made since the beginning of the current session, since the last “apply” command, since the latest saving of a draft copy, or the like. The changes may be indicated explicitly, or symbols of such elements whose data have been edited may be indicated. The indicating of changes may relate to highlighting by an distinctive colour, typeface or use of dedicated markers.

In an example embodiment, a user of the administrator interface may edit the ABAC policy by manipulating certain symbols of the graphical representation. For instance, an adapted drag-and-drop functionality may be available. The adapted drag-and-drop functionality allows a user to activate a symbol (e.g. a Rule, Policy or PolicySet element) by cursor action and to indicate, in a similar fashion, a destination in the graphical representation. Inter alia, rules along the following lines may apply:
B1. If the destination is subordinate to a parent element having only one existing subordinate element, then the user is prompted to select a combining algorithm to apply for the parent element.
B2. If the destination is subordinate to a parent element having one or more existing subordinate elements, then the user will select a position relative to the existing subordinate elements (e.g., before, after, between) by indicating a desired position with the cursor.
B3. An element that becomes a leaf will have any lower collapse control removed.
B4. An element that was a leaf and becomes an inner element will be provided with a lower collapse control.
B5. An attempted drag-and-drop operation which would lead to an invalid syntactical structure in the tree-like graphical representation of the ABAC policy will be rejected.
B6. If an element which has subordinate elements is moved, then the subordinate elements will be moved together with the element.
   The exact formulation of the rules governing the drag-and-drop behaviour of the interface may be determined while respecting the requirements of the applicable ABAC syntax. This is believed to be within the abilities of the average practitioner having access at once to a specification of the applicable ABAC syntax and the above provisional rules B1-B6. In particular, rule B1 is optional and may be excluded.

### 8. Closing Remarks

Even though the present disclosure describes and depicts specific example embodiments, the invention is not restricted to these specific examples. Modifications and variations to the above example embodiments can be made without departing from the scope of the invention, which is defined by the accompanying claims only.

The devices and methods disclosed above may be implemented as software, firmware, hardware or a combination thereof. In a hardware implementation, the division of tasks between functional units referred to in the above description does not necessarily correspond to the division into physical units; to the contrary, one physical component may have multiple functionalities, and one task may be carried out in a distributed fashion, by several physical components in cooperation. Certain components or all components may be implemented as software executed by a digital processor, signal processor or microprocessor, or be implemented as hardware or as an application-specific integrated circuit. Such software may be distributed on computer readable media, which may comprise computer storage media (or non-transitory media) and communication media (or transitory media). As is well known to a person skilled in the art, the term computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media typically embodies computer readable instructions, data structures, program modules or other data in a modulated data signal such as a carrier wave or other transport mechanism and includes any information delivery media.

1. A computer-implemented method of generating, on the basis of a textual representation of an attribute-based access control, ABAC, policy, an equivalent graphical representation of the ABAC policy,
wherein a computer system comprises a plurality of resources and an access control mechanism, which is configured to selectively restrict access to resources in accordance with the textual representation of the ABAC policy,
the method comprising:
defining a graphical symbol being a graphical counterpart of an element of an ABAC policy that is allowed under a predefined policy syntax and, optionally, defining a graphical symbol being a graphical counterpart of an allowed relationship between elements of the policy, wherein symbols are defined for at least a subset of all elements and relationships allowed under the policy syntax;
initiating a data record indicative of a graphical representation; and
traversing the textual representation of the ABAC policy and, in response to encountering an element or relationship for which a symbol has been defined, instantiating a corresponding symbol in the data record.

2. The method of claim 1, further comprising:
defining a textual symbol for at least one element or relationship that is allowed under the predefined policy syntax; and
during said traversing the policy, in response to encountering an element or relationship for which a textual symbol has been defined, instantiating the textual symbol in the data record.

3. The method of claim 1, further comprising defining, as graphical counterparts of elements corresponding to XACML elements PolicySet, Policy and Rule, graphical symbols that agree as to contour and size but differ as to their contour line style.

4. The method of claim 3, further comprising defining, as a graphical counterpart of an element corresponding to XACML element Description, a text string.

5. The method of claim 3, further comprising defining, as a graphical counterpart of a combining algorithm applicable for an element corresponding to any of XACML elements PolicySet, Policy or Rule and itself having two or more subordinates, a text string selected from finite predefined list and located in a specific area inside or next to the defined graphical symbol representing said element.

6. The method of claim 1, said traversing includes instantiating the totality of symbols in the data record while preserving a hierarchic structure of the policy elements.

7. The method of claim 6, wherein, for each element corresponding to any of XACML elements PolicySet, Policy and Rule and having two or more subordinates, instantiating the symbols representing each of the subordinates in such manner that they appear in the same order as in the textual representation.

8. The method of claim 1, wherein, for all elements corresponding to any of XACML elements PolicySet, Policy and Rule, a symbol comprising a lower collapse control is defined for each non-leaf element, and a symbol comprising an upper collapse control is defined for each non-root element, wherein:
each lower collapse control reacts to user manipulation by toggling between a lower expanded mode and a lower collapsed mode with respect to the symbol carrying the lower collapse control; and
each upper collapse control reacts to user manipulation by toggling between an upper expanded mode and an upper collapsed mode with respect to the symbol carrying the upper collapse control.

9. The method of claim 1, wherein said instantiation of a graphical symbol includes annotating the symbol with metadata facilitating back-conversion into a representation in textual form.

10. The method of claim 1, wherein said traversing includes inserting markers into interpretation-exempt portions of the textual representation of the ABAC policy, each marker uniquely identifying a symbol in the graphical representation, to facilitate later searching.

11. The method of claim 1, wherein said traversing includes providing the instantiated symbols with metadata annotations referencing specific portions of the textual representation, to facilitate later searching.

12. The method of claim 11,
further comprising initiating a look-up table,
wherein said traversing further includes adding a metadata annotation, with which symbols is provided, in the look-up table when a new symbol is instantiated.

13. The method of claim 1, wherein a symbol representing an element corresponding to an XACML Rule element comprises a toggle switch representing a configured effect of the element.

14. The method of claim 1, wherein a symbol representing an element corresponding to an XACML PolicySet, Policy or Rule element comprises a field for displaying and modifying a graphical tree representation of an associated element corresponding to an XACML Target element, the field being equipped with at least one of:
a control representing an addition of an AND bifurcation in the tree representation;
a control representing an addition of an OR bifurcation in the tree representation; and
a control representing a deletion of a subtree in the tree representation.

15. The method of claim 14, wherein the tree representation is generated on the basis of a textual representation of said associated element while executing at least one of the following rules:
A1) a presence of N≧2 AnyOf-type elements inside a top Target-type element is translated into an AND bifurcation with N children;
A2) a presence of N≧2 AllOf-type elements inside an AnyOf-type element is translated into an OR bifurcation with N children;
A3) a presence of N≧2 Match-type elements inside an AllOf-type element is translated into an AND bifurcation with N children;
A4) a single AllOf-type element is not translated;
A5) an AnyOf-type element containing only one AllOf-type element is not translated;
A6) a Target-type element containing only one AnyOf-type element is not translated;
A7) a single Match-type element is not translated and its content is translated into a condition at a leaf node of the tree representation.

16. The method of claim 1, wherein said instantiation of a graphical symbol includes annotating the symbol with a visible label indicating whether all information that is mandatory to fulfill syntactic consistency, with respect to a predefined ABAC syntax, is present in the element represented by the symbol.

17. A computer-implemented method of generating, on the basis of a graphical representation of an attribute-based access control, ABAC, policy, an equivalent textual representation of the ABAC policy,
wherein a computer system comprises a plurality of resources and an access control mechanism, which is configured to selectively restrict access to resources in accordance with the textual representation of the ABAC policy,
the method comprising:
obtaining predefined definitions relating on the one hand elements of an ABAC policy that is allowed under a predefined policy syntax, and optionally allowed relationships between elements of the policy, and, on the other hand, graphical symbols;
initiating a data record indicative of a textual representation; and
traversing the graphical representation of the ABAC policy and, in response to encountering a symbol included in the predefined definitions, instantiating a corresponding element or relationship in the data record.

18. The method of claim 17,
wherein the graphical representation includes a symbol representing an element corresponding to an XACML PolicySet, Policy or Rule element with an associated element corresponding to an XACML Target element, the symbol displaying a graphical tree representation of the associated element,
said traversing including, in response to encountering a symbol with these characteristics,
i) initiating an textual representation in the data record corresponding to a TRUE constant nested in a Match-type element nested in an AllOf-type element nested in an AnyOf-type element nested in a Target-type element, and
ii) extending the textual representation thus initiated by traversing the tree representation, to obtain an equivalent Target-type expression.

19. The method of claim 18, wherein step ii is carried out under the assumption that the tree representation was generated in accordance with at least one of the following rules:
A1′) a presence of N≧2 AnyOf-type elements inside a top Target-type element was translated into an AND bifurcation with N children;
A2′) a presence of N≧2 AllOf-type elements inside an AnyOf-type element was translated into an OR bifurcation with N children;
A3′) a presence of N≧2 Match-type elements inside an AllOf-type element was translated into an AND bifurcation with N children;
A4′) a single AllOf-type element was not translated;
A5′) an AnyOf-type element containing only one AllOf-type element was not translated;
A6′) a Target-type element containing only one AnyOf-type element was not translated;
A7′) a single Match-type element was not translated and its content was translated into a condition at a leaf node of the tree representation.

20. A computer-implemented method of providing graphical interaction techniques for configuring an access control mechanism in a computer system,
wherein the computer system further comprises a plurality of resources and the access control mechanism is configured to selectively restrict access to the resources in accordance with a textual representation of an attribute-based access control, ABAC, policy,
the method comprising:
with respect to a textual representation of an ABAC policy, performing the method of providing a graphical representation according to claim 1;
receiving user input referencing the graphical representation and ordering at least one modification of the graphical representation;
with respect to the graphical representation as modified by said user input, performing a method of providing a textual representation, the method comprising: obtaining predefined definitions relating on the one hand elements of an ABAC policy that is allowed under a predefined policy syntax, and optionally allowed relationships between elements of the policy, and, on the other hand, graphical symbols; initiating a data record indicative of a textual representation; and traversing the graphical representation of the ABAC policy and, in response to encountering a symbol included in the predefined definitions, instantiating a corresponding element or relationship in the data record; and causing the textual representation thus obtained to control the access control mechanism of the computer system.

21. The method of claim 20, further comprising:
displaying the graphical representation of the ABAC policy; and
responsive to receiving said user input ordering at least one modification of the graphical representation, displaying the ABAC policy as modified by the user input.

22. The method of claim 21, further comprising repeating, in response to new user input ordering at least one modification of the graphical representation, the steps of providing a textual representation and causing the textual representation to control the access control mechanism of the computer system.

23. The method of claim 20, wherein at least some of the symbols is associated with metadata, the method further comprising:
displaying the graphical representation in a normal mode, wherein metadata are invisible or only partially visible; and
in response to user input, displaying the graphical representation in an expanded mode, wherein metadata are visible and optionally editable.

24. The method of claim 20, implemented by a policy administrator interface associated with an entity serving as policy decision point.

25. The method of claim 20, further comprising, in response to receiving user input ordering addition of a second subordinate of an element corresponding to any of XACML elements PolicySet, Policy and Rule, displaying a menu of available combining algorithms and requesting further user input indicating a selection from the menu for user to apply for said element.

26. The method of claim 20, further comprising displaying the generated graphical representation simultaneously in a main window and an overview window.

27. The method of claim 20, further comprising providing a search functionality for retrieving a search phrase in textual information associated with symbols in the graphical representation.

28. The method of claim 27, wherein the search functionality is configured to display search hits in text format, optionally together with highlighting of any such elements in the graphical representation that contain the search phrase.

29. The method of claim 27, wherein the search functionality is configured to make use of markers in the textual representation or of a look-up table collecting metadata annotations with which symbols of the graphical representation are provided.

30. The method of claim 20, wherein said step of receiving user input comprises receiving textual input while operating one or more of:
an autocomplete functionality configured to recognize reserved words under a predefined ABAC syntax;
an autocomplete functionality configured to recognize attributes in a list of defined attributes;
a syntax consistency aid configured to automatically perform one or more of: bracket matching, automatic indentation, highlighting of reserved words under a predefined ABAC syntax, highlighting of attributes in a list of defined attributes.

31. The method of claim 20, wherein the graphical representation includes at least one symbol annotated with a visible label indicating whether all information that is mandatory to fulfill syntactic consistency, with respect to a predefined ABAC syntax, is present in the element represented by the symbol,
the method further comprising, in response to receiving user input ordering at least one modification of the symbol, verifying whether the symbol thus modified fulfills the predetermined ABAC syntax and updating the visible label accordingly.

32. The method of claim 20, wherein user input ordering at least one modification of the graphical representation is received in the form of a drag-and-drop action allowing the user to activate a symbol and to indicate a destination in the graphical representation, in response to which the graphical representation is modified subject to at least one of the following rules:
B1) if the destination is subordinate to a parent element having only one existing subordinate element, then the user will be prompted to select a combining algorithm to apply for the parent element;
B2) if the destination is subordinate to a parent element having one or more existing subordinate elements, then the user will be prompted to select a position relative to the existing subordinate elements by indicating a desired position with a cursor;
B3) an element that becomes a leaf will have any lower collapse control removed;
B4) an element that was a leaf and becomes an inner element will be provided with a lower collapse control;
B5) an attempted drag-and-drop operation which would lead to an invalid syntactical structure in the tree-like graphical representation of the ABAC policy will be rejected;
B6) if an element which has subordinate elements is moved, then the subordinate elements will be moved together with the element.

33. The method of claim 20, further comprising:
performing consistency verification on the graphical representation of the ABAC policy, wherein consistency is verified in relation to a predefined ABAC syntax; and
visualizing an outcome of said consistency verification in graphical form.

34. A computer-implemented method of providing graphical interaction techniques for configuring an access control mechanism in a computer system,
wherein the computer system further comprises a plurality of resources and the access control mechanism is configured to selectively restrict access to the resources in accordance with a textual representation of an attribute-based access control, ABAC, policy,
the method comprising:
with respect to a textual representation of an ABAC policy, performing the method of providing a graphical representation according to claim 1;
receiving user input referencing the graphical representation and ordering at least one modification of the graphical representation;
retrieving the textual representation, based on which the graphical representation was generated, and initiating a data record indicative of this textual representation;
on the basis of the received user input referencing the graphical representation and ordering at least one modification of the graphical representation, amending the data record incrementally in such manner that equivalent modifications are performed in the indicated textual representation; and
causing the textual representation thus obtained to control the access control mechanism of the computer system.

35. A device comprising a memory and a processor, the processor being configured to perform the method of claim 1.

36. A device comprising a memory, a processor, a visual display and a graphical input modality, the processor being configured to perform the method of claim 20.

37. A computer program product comprising a transitory or non-transitory computer-readable medium with instructions for causing a programmable computer to perform the method of claim 1.
